(19) United States
(12) Patent Application Publication
(10) Pub. No.: US 2025/0233481 A1
(43) Pub. Date: Jul. 17, 2025

(54) THREE-PHASE ELECTRICAL GENERATOR

(71) Applicant: Steeven Gagnon, Notre-Dame-des-Pins (CA)

(72) Inventor: Steeven Gagnon, Notre-Dame-des-Pins (CA)

(21) Appl. No.: 18/638,494

(22) Filed: Apr. 17, 2024

(30) Foreign Application Priority Data
Jan. 17, 2024 (CA) 3226348

(51) Int. Cl. H02K 7/18; H02K 1/14

(52) U.S. Cl. CPC H02K 7/1823; H02K 1/146

(57) ABSTRACT

The invention is a new three-phase electrical generator having a significant improvement in its energy efficiency while respecting the industry standards.

The invention relates to a three-phase electrical generator for improving the electrical production of existing infrastructures.

Most power plants operate with a thruster coupled directly to a single electrical generator. The number of magnetic poles inside the electric generator as well as its rotation speed determine its output frequency. With a pair of magnetic poles, a north pole and a south pole, the electric generator will generally spin at 3,600 revolutions per minute to produce a frequency of 60 hertz in North America and at 3,000 revolutions per minute to produce a frequency of 50 hertz for other territories.

The electrical generators used are generally radial flux or axial flux generators.

Although it is possible to have single-phase generators, most generators used are three-phase generators. That is, inside the electric generator there are three separate phases which are powered by the north poles and south poles of the rotating rotor. The three phases are offset by 120 degrees each.

Three-phase systems offer different electrical connection modes to adjust to the difference in power required by society. One of the possible connections is the delta connection between the phases which offers more voltage since the phases are connected in series. It is also possible to connect the phases in wye, which offers a slightly lower voltage. Another possibility is to use a single phase with a neutral wire in the center of the wye connection to produce single phase current. The latter is widely used to connect residences to the electrical grid, while the other connection types are used for applications requiring more power.

Three-phase and single-phase connections are established as an industry standard and are widely used across the globe.

According to the invention, it is possible to increase the efficiency by changing the assembly parameters of the electrical generator. According to the invention, the generator can also be single-phase or three-phase depending on its configuration. In single-phase this is composed of a single phase which has several windings. In three-phase each of the phases also has several windings. Unlike a conventional generator where the three phases would be assembled together in the same case, the three phases each are separated to be assembled on the same axis of rotation with at least three rotors and at least three stators. This configuration makes it possible to reduce the phase assembly radius while reducing the resistance force applied to the thruster. For example, if the radius of the phases is reduced by three according to the lever formula, the resistance applied to the thruster will also be divided. Rotors and stators can be assembled on the same shaft or separated using a gear system to fit them all together.

In order for each of the three phases to create three unsynchronized sinusoidal curves, they must be positioned on the same axis in relation to each other so that the phases are offset by 120 degrees.

The rotors used in the invention have at least one pair of magnetic poles, namely a south pole and a north pole.

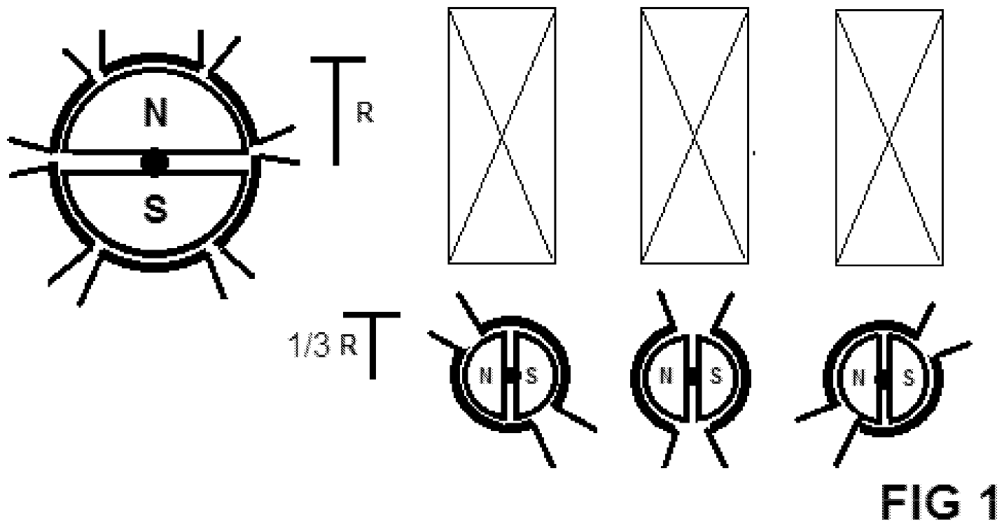

FIG. 1 Represents on the left a conventional generator with 3 phases in the same case having a standard assembly radius. On the right we can see the 3 phases separated to form 3 individual phases with 3 stators & 3 rotors with a given shorter assembly radius & having each of the phase an offset by 120 degrees.

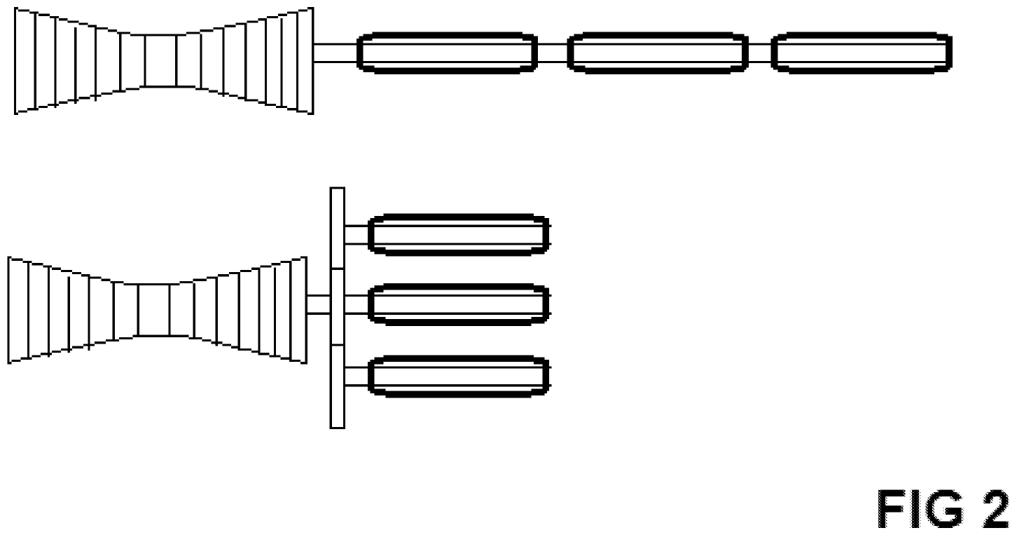

FIG. 2 Represents at the top a steam turbine attached to the 3 phases on the same shaft and at the bottom a steam turbine attached to the 3 phases by a gear system.

FIG. 3 Represents the spreadsheet to demonstrate the energy efficiency gain achieved by using 3 phase separations with a ⅓ shorter assembly radius.

According to the invention, the generator can be powered by a steam turbine, wind turbine blades, a tidal turbine, a hydroelectric turbine, a combustion engine or an electric motor.

It is possible to increase or reduce the power of the generator in order to adapt to the demand of the societies.

By reducing the assembly radius, this allows additional energy savings to be made.

The energy efficiency of the generator set is essential to reduce greenhouse gas emissions into the atmosphere. The new generator can have a positive impact for the planet.

1. A new three-phase electric generator is proposed where each of the three phases comprises at least one rotor and at least one stator and where each of the three phases rotors & stators are linked together on the same shaft or by a gear system & which the phase assembly radius is shorter thanks to the adjacent positioning of the stators and rotors on the same axis of rotation & each of the three phases stators or rotors must be positioned on the same axis in relation to each other so that the three phases are offset by 120 degrees.
